(19) United States
(12) Patent Application Publication
(10) Pub. No.: US 2017/0091753 A1
(43) Pub. Date: Mar. 30, 2017

(54) SENSORY FEEDBACK PAYMENT SYSTEM

(71) Applicant: PAYPAL, INC., San Jose, CA (US)

(72) Inventor: Ryan Christopher May, San Jose, CA (US)

(21) Appl. No.: 14/867,794

(22) Filed: Sep. 28, 2015

(51) Int. Cl. G06Q 20/32; G06Q 20/40; G06Q 20/42

(52) U.S. Cl. CPC G06Q 20/3278; G06Q 20/42; G06Q 20/405

(57) ABSTRACT

Systems and methods for providing a sensory feedback payment system include a system provider device that receives, through communication over a network with a merchant device that is located at a merchant physical location, a request to debit an amount from a customer payment account. The sensory feedback may include at least one of vibrational feedback and audio feedback. The system provider also determines at least one sensory feedback parameter based on the amount. Thereafter, the system provider device may debit the amount from the customer payment account. In response to debiting the amount, the system provider sends an instruction to provide sensory feedback to a user through a customer device, where the sensory feedback is determined by the at least one sensory feedback parameter. Thus, the system provider provides a method to physicalize e-commerce purchase transactions, thereby increasing the trust, security, and accessibility of using electronic currency.

### BACKGROUND

Field of the Invention

The present disclosure generally relates to online and/or mobile payments, and more particularly to a sensory feedback payment system that may be used to provide haptic/tactile and/or audio feedback to a customer based on an online and/or mobile payment transaction.

Related Art

More and more consumers are purchasing items and services over electronic networks such as, for example, the Internet. Consumers routinely purchase products and services from merchants and individuals alike. The transactions may take place directly between a conventional or on-line merchant or retailer and the consumer, and payment is typically made by entering credit card or other financial information. Transactions may also take place with the aid of an on-line or mobile payment service provider such as, for example, PayPal, Inc. of San Jose, Calif. Such payment service providers can make transactions easier and safer for the parties involved. Purchasing with the assistance of a payment service provider from the convenience of virtually anywhere using a mobile device is one main reason why on-line and mobile purchases are growing very quickly.

Some payment service providers provide online and mobile payment services for merchants with merchant physical locations and their customers in order to allow the customers to make purchases from the merchants at the merchant physical locations. When shopping at a particular merchant physical location (e.g., a department store, a grocery store, etc.), customers may pay for goods and/or services at the merchant physical location using cash, which is tangible and is often provided in varying banknote or coin colors, sizes, weights, and may include a variety of printed, stamped, engraved, and/or imprinted text and images, or other tactile features. Such attributes readily help customers determine an amount spent and provides security, for example, in helping customers quickly determine that they were properly charged and given accurate change. Moreover, the attributes of tangible currency also provide accessibility to customers with disabilities (e.g., visually impaired customers) who may rely on such attributes for successful and safe completion of their purchases. However, there are currently no such physical attributes associated with electronic currency and/or electronic transactions. Thus, purchase transactions conducted online and/or via a mobile payment system, even when the transaction is performed at a merchant physical location, do not provide customers the same tangible and visual features of physical currency, resulting in a loss of security, accessibility, and peace of mind.

Thus, there is a need for a sensory feedback payment system that provides customers with a reliable and transparent way to receive haptic/tactile and/or audio feedback based on an online and/or mobile payment transaction, thereby increasing the trust, security, and accessibility of using electronic currency.

### BRIEF DESCRIPTION OF THE FIGURES

FIG. 1 is a schematic view illustrating an embodiment of a sensory feedback payment system;

FIG. 2 is a flow chart illustrating an embodiment of a method for providing sensory feedback to a customer engaging in a payment transaction;

FIG. 3 is a screen shot illustrating an embodiment of a customer device displaying a customer check-in screen at a merchant location;

FIG. 4 is a schematic view illustrating an embodiment of a sensory feedback payment system including a customer conducting a transaction at a merchant point of sale;

FIG. 5 is a schematic view illustrating an embodiment of a sensory feedback payment system including an near field communication (NFC) terminal and an NFC-enabled customer device;

FIG. 6 is a schematic view illustrating an embodiment of a customer device which may provide sensory feedback such as haptic/tactile feedback and/or audible feedback;

FIGS. 7 and 8 illustrate waveform profiles corresponding to a variety of sensory feedback parameters, in accordance with some embodiments;

FIG. 9 is a bar graph illustrating an embodiment of adjusting a vibration duration based on an amount to be debited from a customer payment account;

FIG. 10 is a bar graph illustrating an embodiment of using the vibration duration-banknote denomination linkages (of FIG. 9) to represent various exemplary amounts which may be debited from the customer payment account;

FIG. 11 is a schematic view illustrating an embodiment of a networked system;

FIG. 12 is a perspective view illustrating an embodiment of a customer device;

FIG. 13 is a schematic view illustrating an embodiment of a computer system; and

FIG. 14 is a schematic view illustrating an embodiment of a system provider device.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides systems and methods for providing a sensory feedback payment system that provides customers with a reliable and transparent way to receive haptic/tactile and/or audio feedback based on an online and/or mobile payment transaction, thereby increasing the trust, security, and accessibility of using electronic currency and/or participating in electronic transactions. As used herein, the term “haptic feedback” may be used interchangeably with the term “tactile feedback”, both of which may be generally used to refer to applied forces, vibrations, motions, or other sensory inputs that may be felt by a user (e.g., by way of a customer device), where such haptic/tactile feedback is used to convey information (e.g., related to the amount of a purchase transaction) to the user/operator of the customer device). In addition, a “time-of-purchase”, as described herein, may include a time at which a purchase transaction occurs at a physical point of sale (e.g., at a physical merchant location) or at a virtual point of sale, and including for example, a virtual storefront accessible to a customer via a website (e.g., accessible through an Internet connection using a mobile device and/or a personal computer). In other examples, such a virtual storefront may be accessible to a customer by way of a mobile application executing on the customer's mobile device.

Conventionally, and in particular prior to the advent of computer networks and the Internet, customers going through a checkout process (i.e., itemization and collection of an amount due for purchases) at a physical point of sale would pay with cash, which is tangible and is often provided in varying banknote or coin colors, sizes, weights, and may include a variety of printed, stamped, engraved, and/or imprinted text and images, or other tactile features. Such physical attributes readily help customers determine an amount spent and provides security, for example, in helping customers quickly determine that they were properly charged and given accurate change. Moreover, the attributes of tangible currency (i.e., cash) also provide accessibility to customers with disabilities (e.g., visually impaired customers) who may rely on such attributes for successful and safe completion of their purchases.

With the advent of computer networks and the Internet, and the subsequent expansion of electronic commerce (e-commerce), electronic currency and digital wallets have established themselves as an important part of the e-commerce ecosystem. As used herein, the term “electronic currency” may be generally used to refer to a digital or electronic representation of physical currency (e.g., coins and banknotes) which may be used to conduct financial transactions electronically (e.g., via an Internet-based medium of exchange). In addition, as used herein, the term “digital wallet” may be generally used to refer to an electronic device (e.g., such as a smartphone, tablet, computer, etc.) that allows a customer to make e-commerce transactions, for example, using funds from a customer bank account or payment service provider account (e.g., a PayPal account) that is linked to the digital wallet.

Of particular note, the rise of e-commerce, electronic currency, and digital wallets has introduced problems associated with the handling of currency, or other monetary instruments, that did not exist prior to the advent of computer networks and the Internet. For example, electronic currency and digital wallets provide none of the tactile features provided by physical currency, as discussed above. Thus, purchase transactions conducted online and/or via a mobile payment system, even when the transaction is performed at a merchant physical location, do not provide customers the same tangible and/or visual features of physical currency, resulting in a loss of security, accessibility, and peace of mind. By providing tactile feedback to the customer at the time-of-purchase, for purchase transactions conducted online and/or via a mobile payment system, the customer would regain a sense trust in knowing they were not overcharged or unknowingly charged. In addition, such tactile feedback would greatly increase the accessibility of online and/or mobile payments to disabled customers (e.g., visually impaired customers) who may rely on the tactile features of physical currency to safely conduct purchases or other financial transactions. Thus, in accordance with the various embodiments described herein, tactile feedback (and in some cases audible feedback) may be provided to customers at a time-of-purchase, for example, for purchase transactions conducted online and/or via a mobile payment system. The embodiments described herein thereby provide a customer with a reliable and transparent way to receive tactile feedback (and audible feedback) based on an online and/or mobile payment transaction, thereby increasing the trust, security, and accessibility of using electronic currency and/or digital wallets.

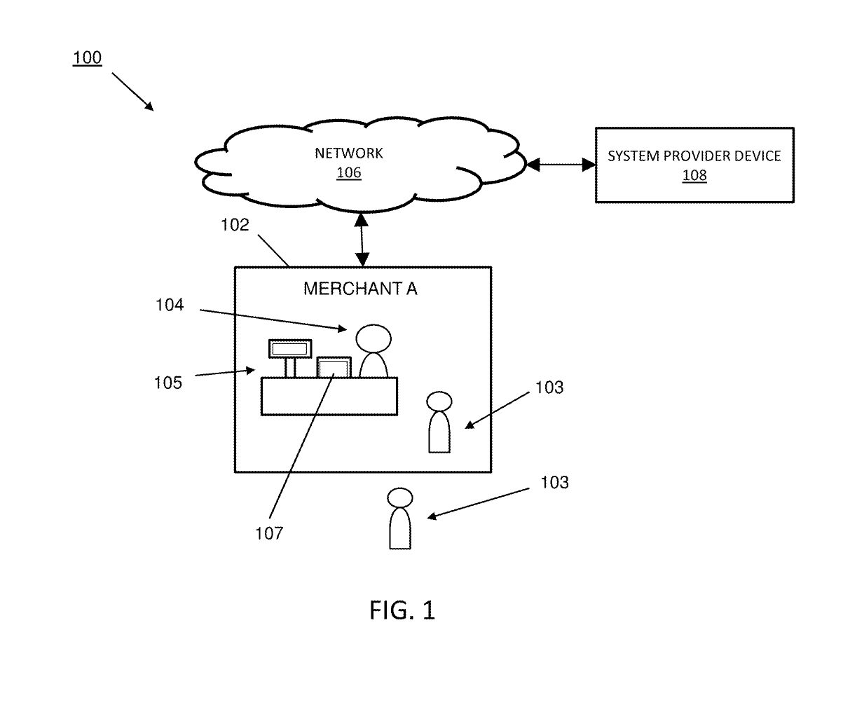

Referring now to FIG. 1, an embodiment of a sensory feedback payment system 100 is illustrated. The sensory feedback payment system 100 includes a merchant 102 (illustrated and equivalently referred to as “Merchant A”) having a merchant physical location. While the embodiments herein are shown and described with reference to a single merchant for the sake of clarity, it will be understood that various embodiments may include a plurality of merchants at a plurality of merchant physical locations, and/or a single merchant having a plurality of merchant physical locations. In various examples, the merchant 102 includes one or more merchant devices that are coupled to a network 106 that is further coupled to a system provider device 108. For example, the merchant 102 and the system provider device 108 are configured to communicate with one another by way of the network 106, for example by way of network communication devices, as discussed below. In some embodiments, the merchant 102 further includes a point of sale 105 (e.g., a cash register) of the Merchant A. In various examples, the point of sale 105 may include an electronic or manual cash register, a barcode scanner or barcode reader, a near field communication (NFC) terminal, a scale, and/or other point of sale features known in the art. In some examples, the point of sale 105 may include a display terminal 107 configured to display a customer photo or icon to assist a Merchant A employee 104 with identification of a customer (e.g., during a purchase) to ensure accurate completion of a customer transaction, as described in more detail below.

In the embodiments illustrated and discussed below, the merchant 102 may provide a department store. However, one of skill in the art in possession of the present disclosure will recognize that the sensory feedback payment system 100 described herein may be utilized with virtually any merchant type located at virtually any merchant physical location such as, for example, a restaurant, a grocery store, a pharmacy, a movie theater, a theme park, a sports stadium, and/or a variety of other merchant physical locations known in the art. Moreover, in some embodiments, the merchant 102 physical location may include a mobile merchant location such as a cart, kiosk, trailer, and/or other mobile merchant location as known in the art.

The network 106 may be implemented as a single network or a combination of multiple networks. For example, in various embodiments, the network 106 may include the Internet and/or one or more intranets, landline networks, wireless networks, cellular networks, satellite networks, and/or other appropriate types of networks. In some examples, the merchant 102 may communicate through the network 106 via cellular communication, by way of one or more merchant network communication devices. In other examples, the merchant 102 may communicate through the network 106 via wireless communication (e.g., via a WiFi network), by way of one or more merchant network communication devices. In yet other examples, the merchant 102 may communicate through the network 106 via any of a plurality of other radio and/or telecommunications protocols, by way of one or more merchant network communication devices. In still other embodiments, the merchant 102 may communication through the network 106 using a Short Message Service (SMS)-based text message, by way of one or more merchant network communication devices.

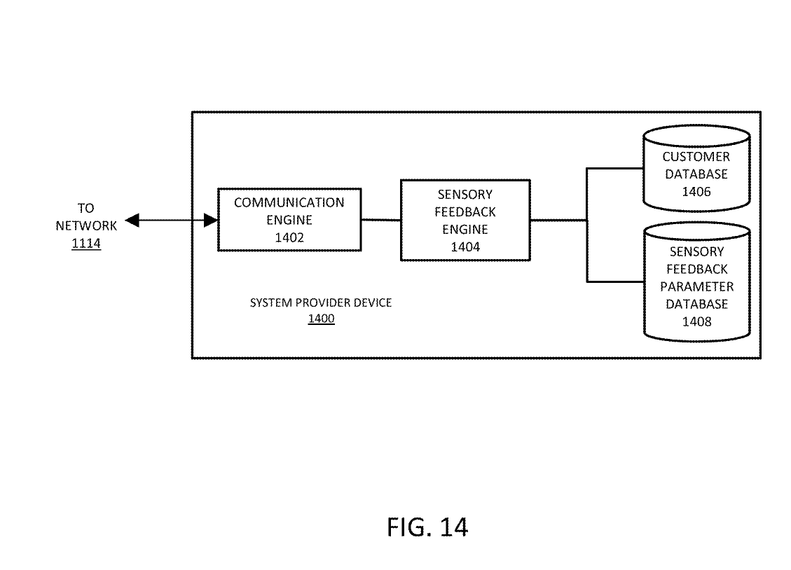

The system provider device 108 may likewise couple to the network 106 via a wired or wireless connection. As described in more detail below with reference to FIG. 14, the system provider device 108 may include a sensory feedback engine, a communication engine, a sensory feedback parameter database, and a customer database. Software or instructions stored on a computer-readable medium, and executed by one or more processors of the system provider device 108, allows the system provider device 108 to send and receive information over the network 106. Furthermore, the sensory feedback engine in the system provider device 108 may be configured to implement the various embodiments of the sensory feedback payment system as described herein. In some examples, the system provider device 108 is configured to receive a request (e.g., from a merchant) to debit an amount from a customer payment account and determine at least one sensory feedback parameter based on the amount to be debited. Thereafter, the system provider device 108 is configured to debit the amount (or authorize the debit) from the customer payment account and provide haptic/tactile feedback (e.g., vibrational feedback) to a user by way of a customer device to convey information (e.g., regarding an amount of a purchase transaction) to the user/operator of the customer device. In various embodiments, the haptic/tactile feedback may include a profile (e.g., a vibration profile and/or an audio profile) determined at least partly by the at least one sensory feedback parameter.

Consider, as one example, a sensory feedback parameter including vibration duration. In some embodiments, a first vibration duration may be determined based on a first debit amount, and a second vibration duration may be determined based on a second debit amount. In response to debiting the first or second amount from the customer payment account, the customer device may provide vibrational feedback for a duration equal to the first or second vibration duration, respectively. Thus, the system provider device 108 provides the user with a way to physically sense whether an e-commerce purchase transaction has debited an expected amount from the customer payment account, as described in more detail below. More generally, embodiments of the present disclosure provide customers, at a time-of-purchase, with haptic/tactile feedback, and in some examples audible feedback, for online and/or mobile payment transactions to convey information (e.g., regarding an amount of the purchase transaction) to the user/operator of the customer device, thereby improving the trust, security, and accessibility of using electronic currency and/or digital wallets.

In the embodiment illustrated in FIG. 1, one or more customers 103 may be shopping at, arriving at, or leaving from the Merchant A physical location. In some embodiments, the arrival, departure, and/or position of the one or more customers 103 may be detected by way of one or more beacon devices in a beacon system implemented at the Merchant A physical location. In some embodiments, the system provider may include a payment service provider such as, for example, PayPal Inc. of San Jose, Calif., that provides the sensory feedback payment system 100 for the merchant 102 at the merchant location, as well as any other merchants implementing the sensory feedback payment system 100. In some embodiments, as discussed below, the payment service provider processes payment requests from the merchant 102, processes payments from customers to the merchant 102, and may associate a merchant physical location (or its merchant such as merchant 102), a customer location (or its customer), merchant devices, customer devices, and/or other components of the sensory feedback payment system 100 with a merchant account in a database located in a non-transitory memory. For example, the payment service provider may use a payment service provider device to transfer funds from a customer payment account (e.g., provided by an account provider through an account provider device, provided by the payment service provider through the payment service provider device, etc.) of the customer to a merchant account (e.g., provided by an account provider through an account provider device, provided by the payment service provider through the payment service provider device, etc.) of the merchant to provide payment from the customer to the merchant during a transaction. In some examples, the payment service provider may also determine sensory feedback parameters, for example, based on the payment requests and/or funds transfers described above. Additionally, in various embodiments, the payment service provider may provide one or more sensory feedback profiles (e.g., vibrational profiles and/or audio profiles) to a customer device, where the one or more sensory feedback profiles are determined at least in part by one or more of the sensory feedback parameters.

Information sent and received through the network 106, merchant devices, and customer devices may be associated with merchant 102 accounts in the database, and any use of that information may be stored in association with such merchant 102 accounts. Furthermore, the payment service provider may provide the sensory feedback payment system 100 for a plurality of different merchants at various merchant physical locations, similarly as described for the merchant 102, discussed below. Thus, references to a system provider operating a system provider device below may refer to a payment service provider operating a payment service provider device, or may refer to any other entity providing a sensory feedback payment system separate from or in cooperation with a payment service provider.

In the embodiments discussed below, the sensory feedback payment system and related methods involve a system provider using a system provider device to detect events associated with a merchant point of sale transaction (e.g., scanning an item at a register of a merchant physical location) by communicating, for example through beacon devices or other appropriate communication devices with customer devices and/or merchant devices at the merchant physical location associated with the merchant 102. In some embodiments, events associated with a merchant point of sale transaction may also include events associated with a merchant virtual storefront, such as proceeding to a “checkout” portion of a merchant online payment interface and/or completing an online purchase. The system provider device may also retrieve information related to one or more payment accounts available to a customer, as well as information regarding forms of payment which the merchant 102 accepts. Additionally, the system provider device may maintain a running total cost and/or save a final total cost of item(s) selected for purchase and determine one or more sensory feedback parameters based on the running total cost and/or the final total cost. The system provider device may further generate, and/or otherwise provide, a haptic/tactile feedback profile that is determined at least partly by the one or more sensory feedback parameters, as described below. Generally, using the haptic/tactile and/or audio feedback profiles, the system provider device may provide customers with haptic/tactile feedback and/or audible feedback (e.g., by way of a customer device) that is directly associated with a transaction and/or purchase amount, such as the final total cost of item(s) selected for purchase. The system provider device may also store customer and/or merchant information (e.g., customer payment account information, customer payment preferences, merchant payment preferences, merchant physical location, customer physical location, etc.) in a database located at the merchant physical location associated with the merchant 102 and/or the customers, or at a remote database, for example, by way of a network connection. In some embodiments, the system provider device may be a merchant device that is local to the merchant physical location associated with the merchant 102 and that communicates with the beacon devices, or other appropriate communication devices, for example using a merchant network communication device. In other embodiments, the system provider may be, for example, a payment service provider as discussed above.

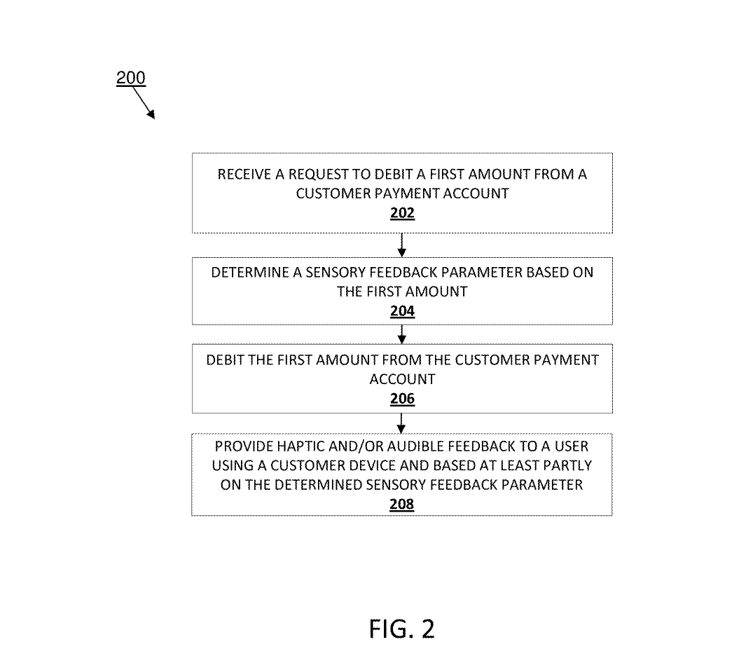

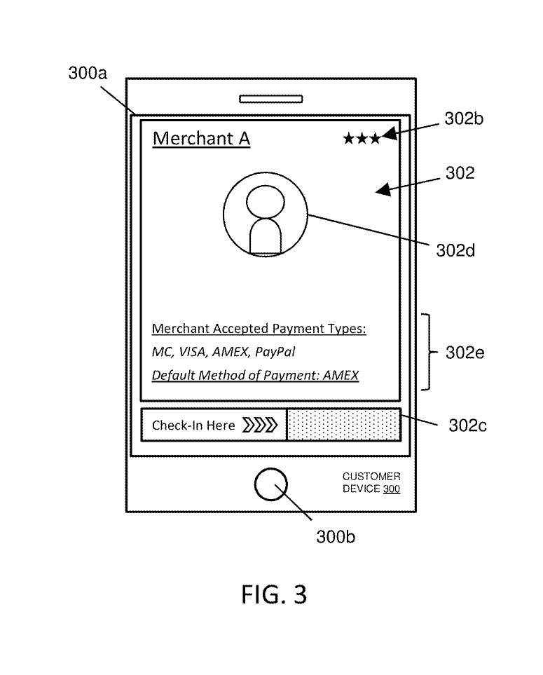

Referring now to FIG. 2, an embodiment of a method 200 for providing haptic/tactile feedback (and in some cases audible feedback) to a customer based on a transaction amount is illustrated. One of skill in the art in possession of the present disclosure will recognize that the method 200 may be performed for a plurality of different merchants at a variety of physical locations. It will also be understood that additional steps may be performed before, during, and/or after the steps described below with reference to the method 200. The method 200 begins at block 202 where a request to debit a first amount from a customer payment account is received. In particular, with reference to FIGS. 3-10, various aspects of the method 200 are illustrated and described.

Referring first to FIG. 3, a customer device 300 is illustrated that includes a display 300a, for example having a touchscreen user interface, and an input button 300b. While the customer device 300 is illustrated and described as a mobile phone, a variety of other customer devices are envisioned as falling within the scope of the present disclosure. In various embodiments, a customer associated with the customer device 300 may launch a system provider application and/or a payment service provider application (e.g., a payment application provided by PayPal, Inc. of San Jose, Calif.). In some embodiments, a location of the customer device 300 may be determined by the system provider (e.g., using GPS coordinates, triangulation, or other location determination techniques). In some examples, information for a local merchant (e.g., “local” meaning near the present location of the customer device 300) is displayed in a display 302 of the customer device 300. In the example of FIG. 3, information for a merchant “Merchant A” is displayed in the display 302. In addition to displaying a merchant name, the display 302 may also include a merchant rating 302b, and a check-in slider 302c that allows customers in proximity to a merchant location to “check-in” to the merchant location, as discussed below. In some examples, a customer photo or icon 302d may also be displayed, for example, to assist a merchant with identification of a customer to ensure accurate completion of a customer transaction. In addition, in some examples, a payment information portion 302e may be displayed. As shown in FIG. 3, the payment information portion 302e may include information regarding merchant accepted payment types (e.g., types of credit and/or debit cards that the merchant accepts), as well as a customer default and/or preferred method of payment (e.g., a default and/or preferred credit or debit card).

In some embodiments, when a customer is in proximity to the merchant 102 location (e.g., determined via the customer device 300 associated with the customer), then the customer may be allowed to “check-in” to the merchant 102 location. In some examples, the customer may check-in to the merchant 102 location by sliding the check-in slider 302c from left to right across the touchscreen user interface of the customer device 300. In embodiments of the present disclosure, a customer may “check-in” in order to pay for goods and/or services by, for example, utilizing a payment service provider (e.g., PayPal, Inc.). In some embodiments, the customer may be automatically checked-in to the merchant 102 location, for example, when the customer is in proximity to the merchant 102 location. In some examples, when a customer checks-in to the merchant 102 location, the system provider device 108 may notify the merchant 102. In some embodiments, such a check-in notification received by a merchant 102 device from the system provider device 108 may include the customer photo or icon 302d. In some embodiments, after a customer has checked-in and in an embodiment of block 202 of the method 200, the merchant may request to debit an amount from the customer payment account for goods provided and/or services rendered.

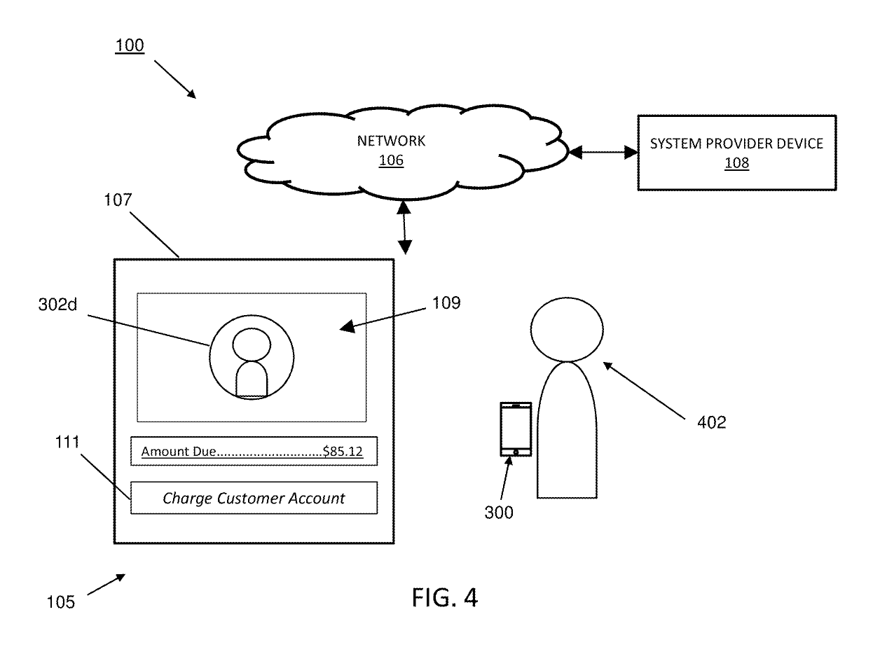

In various examples, determination of the amount to be debited from the customer payment account for the goods provided and/or services rendered may be performed according to any of a variety of suitable techniques. In some examples, with reference to FIG. 4, a customer 402 (checked-in to the merchant 102 location using the customer device 300) has selected one or more items for purchase and has approached a point of sale, such as the point of sale 105 discussed above with reference to FIG. 1. As shown in FIG. 4, the point of sale 105 may include a display terminal 107 having a display 109 configured to display the customer photo or icon 302d to assist a merchant employee with identification of the customer 402, for example, to ensure that the correct customer's payment account is to be debited for the transaction. By way of example, barcode(s) of the customer's selected item(s) may be scanned by a merchant employee (e.g., using a barcode scanner or reader), and a total cost for the selected item(s) may be determined by the point of sale 105. In some embodiments, after the merchant employee has confirmed the customer identification (e.g., via the photo or icon 302d), the merchant employee may select/tap a charge confirmation portion 111 of the display 109 (e.g., to initiate a debit request), and the point of sale 105 may communicate (e.g., via the network 106, to the system provider device 108) a total amount to be debited from the customer's 402 payment account (e.g., in conjunction with the debit request of block 202) based on the determined total cost for the selected item(s) and any applicable taxes, discounts, etc. In some embodiments, the point of sale 105 includes a customer self-service register, and the customer 402 may thereby scan the barcode(s) of the selected item(s) themselves and confirm payment via a display of the customer self-service register (e.g., initiate a debit request), resulting in communication of the total amount to be debited from the customer's 402 payment account (e.g., in conjunction with the debit request of block 202), via the network 106, to the system provider device 108. In some examples, a merchant employee may manually enter the cost of each of the selected item(s) and/or may manually enter a total amount due from the customer for payment of the selected item(s). Thereafter, in some embodiments, the merchant employee may manually submit and/or initiate the request to debit the total amount due from the customer payment account (e.g., via the charge confirmation portion 111 of the display 109).

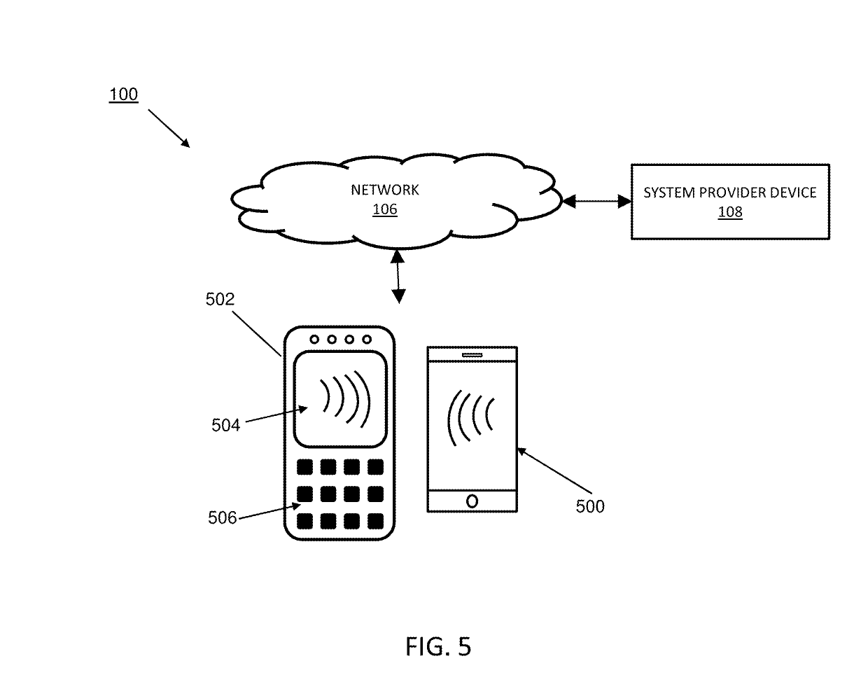

In some embodiments, and with reference to FIG. 5, the point of sale 105 may include a near field communication (NFC) terminal 502 including an NFC chip that enables the NFC terminal 502 to communicate with other NFC-enabled devices. Additionally, in some embodiments, the NFC terminal 502 may include a display 504 and a plurality of buttons 506. In some examples, a merchant employee may use the plurality of buttons 506 to enter a total amount due from the customer for payment of the selected item(s). By way of illustration, in some cases the determination of a total amount to be debited from a customer payment may proceed via barcode scanning, as described above. Regardless of whether the total amount to be debited from the customer payment account is manually entered or determined via barcode scanning, in various embodiments initiation of the request to debit the total amount due from the customer payment account may occur as part of an NFC transaction, through the NFC terminal 502 that may be integrated with the point of sale 105. To be sure, in some instances, the merchant employee may alternatively use the plurality of buttons 506 to submit and/or initiate the request to debit the total amount due from the customer payment account.

With regard to initiating/triggering the request to debit the total amount due by way of an NFC transaction, consider a customer device 500 including an NFC chip that allows the customer device 500 to communicate with the NFC terminal 502. In some cases, for example after a total amount due from the customer for payment of the selected item(s) has been determined, the customer may place the customer device 500 in close proximity to the NFC terminal (e.g., within a few centimeters) in order to initiate an NFC transaction, and thereby initiate the request to debit the total amount due from the customer payment account. By way of example, an exemplary NFC transaction may include one or more steps including (1) token generation from a primary account number (PAN) (e.g., by an issuing bank and/or token service provider (TSP)); (2) token storage onto the customer device 500 (e.g., as part of a digital wallet); (3) token transfer to the merchant via communication between the customer device 500 and the NFC terminal 502; (4) token transfer from the merchant to an acquiring bank and subsequently to the issuing bank and/or TSP, where de-tokenization of the PAN occurs; (5) payment authorization decision by the issuing bank; (6) regeneration of the token from the PAN (e.g., by the issuing bank or the TSP); and (7) transmission of token and payment authorization decision to the merchant (e.g., by way of the acquiring bank).

In some embodiments, various alternative methods and/or mechanisms may be used to submit and/or initiate the request to debit the total amount due from the customer payment account. For example, in some cases, a pay code including a one-dimensional barcode or a two-dimensional matrix barcode, a quick response (QR) code, or other suitable code may be uniquely generated by the system provider device 108 (e.g., for every purchase transaction), and the customer may scan the generated pay code with the customer device 300, 500, thereby initiating the request to debit the total amount due from the customer payment account. In some embodiments, the system provider device 108 may generate a pay code including a unique numeric code that may appear on a display of the customer device (e.g., the display 302 of the customer device 300), and a customer may convey the numeric code to the merchant, whereby the merchant may input the numeric code into the point of sale 105 and thus initiate the request to debit the total amount due from the customer payment account. While some examples of determining a total amount to be debited from a customer payment account, as well as some examples of initiation of and/or communication of the request (to debit the total amount due) to the system provider device 108, have been provided, those skilled in the art in possession of the present disclosure will recognize other methods of determining an amount to be debited and/or methods to initiate/communicate the debit request (including the amount to be debited) to the system provider device 108, while remaining within the scope of the present disclosure.

Thus, following block 202, the system provider device has received a request to debit a specified amount from the customer payment account for goods provided and/or services rendered. As discussed below, knowing the amount to be debited, the system provider device may thus determine one or more sensory feedback parameters and provide haptic/tactile feedback to the customer (e.g., via the customer device 300) based at least partly on the determined sensory feedback parameters.

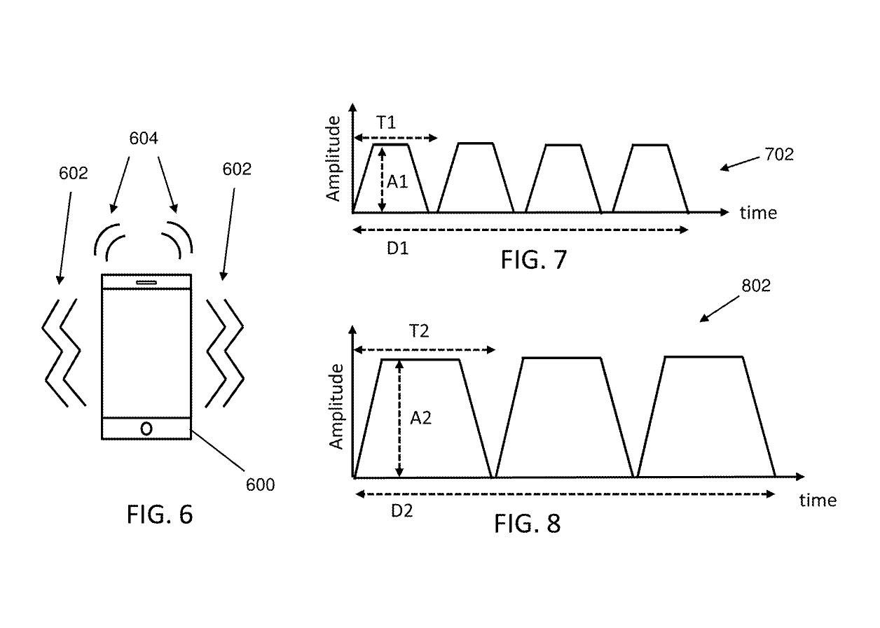

The method 200 proceeds to block 204 where one or more sensory feedback parameters are determined based on the amount specified to be debited from the customer payment account. With reference to the example of FIGS. 6-8, an embodiment of block 204 is illustrated. Aspects of FIGS. 6-8 discussed here may also be applicable to block 208 of the method 200, as described in more detail below. Referring first to FIG. 6, illustrated therein is a customer device 600 (that may include the customer devices 300 and 500), which may provide sensory feedback such as haptic/tactile feedback 602 and/or audible feedback 604 to convey information (e.g., regarding an amount of a purchase transaction) to the user/operator of the customer device 600. In various embodiments, the one or more sensory feedback parameters may include an amplitude, duration, period, frequency, or other parameter, for example, of a component of the customer device 600 which may be adjusted or otherwise modified (e.g., by the system provider) based on the amount specified to be debited from the customer payment account. In some embodiments, such a component (with adjustable sensory feedback parameters) of the customer device 600 may include a DC coreless vibrating motor, a linear resonant actuator (LRA), an iron core vibrating motor, or other suitable micro-drives or motors configured to provide any of a variety of vibrational waveforms (e.g., vibrational profiles). Additionally, in some embodiments, the customer device 600 component may include one or more speakers such as an electrodynamic speaker, a piezoelectric speaker, or other suitable speaker configured to provide any of a variety of audio waveforms (e.g., audio profiles).

FIGS. 7 and 8 provide examples to help describe the one or more sensory feedback parameters of the customer device 600 components which may be adjusted or otherwise modified (e.g., by the system provider) in order to tune the haptic/tactile feedback 602 and/or the audible feedback 604. Referring first to FIG. 7, shown therein is a waveform profile 702, plotted as amplitude versus time, which may be used to illustrate a vibrational profile or an audio profile. FIG. 8 shows a waveform profile 802, also plotted as amplitude versus time, which may similarly be used to illustrate a vibrational profile or an audio profile. By way of example, the waveform profile 702 has an amplitude ‘A1’, a duration ‘D1’, and a period ‘T1’ (frequency ‘F2’=1/T1), and the waveform profile 802 has an amplitude ‘A2’ greater than the amplitude ‘A1’, a duration ‘D2’ greater than the duration ‘D1’, and a period ‘T2’ (frequency ‘F2’=1/T2) greater than ‘T1’. In various embodiments, one or more of the sensory feedback parameters may be used to adjust a vibration intensity, vibration duration, vibration frequency, or other vibration feature of the customer device 600. Similarly, in some embodiments, one or more of the sensory feedback parameters may be used to adjust the intensity, duration, frequency, or other feature of an audio alert or other audible message output from speakers of the customer device 600. It will be understood that the waveform profiles 702, 802 are provided merely for illustration, are not meant to be limiting in any way, and any of a plurality of other waveform profiles may equally be provided, while remaining within the scope of the present disclosure. For example, in some cases, the waveform profiles include non-periodic waveforms.

In various embodiments, values of each of the amplitude, duration, period, and frequency of the waveforms 702, 802 may be adjusted, for example, by the system provider device 108 upon knowing the specified amount to be debited from the customer payment account. Thus, as discussed below, upon subsequent debiting of the amount from the customer payment account, the intensity, duration, frequency, etc., of a customer device vibration or audio alert/audible message output from the customer device may be adjusted in correspondence with the sensory feedback parameters as determined and set by the system provider device 108. Illustratively, values of each of the one or more sensory feedback parameters may be adjusted in correlation with the specified amount to be debited. As merely one example, a larger amount to be debited from the customer payment account may result in the system provider increasing a waveform amplitude or duration, which may correspond to an increased amplitude intensity of a motor vibration or an increased volume of an audible alert, or which may correspond to an increased duration of the motor vibration or of the audible alert. Thus, with reference to the example of FIGS. 7 and 8, the waveform 802 may correspond to a larger amount to be debited from the customer payment account, as compared to the waveform 702 (e.g., since ‘A2’ is greater than ‘A1’ and ‘D2’ is greater than ‘D1’). In some embodiments, period/frequency may similarly be adjusted in response to the specified amount. To be sure, any of the sensory parameters discussed herein may be adjusted in a custom, application-specific manner.

Generally, and with respect to the various embodiments described herein, each of the sensory feedback parameters including amplitude, duration, period, and frequency (as well as other known parameters) may be applicable to any component of the customer device 600 having adjustable parameters and including any of the components discussed above configured to provide vibrational profiles (e.g., vibrating motor, LRA, etc.) or audio profiles (e.g., electrodynamic speaker, piezoelectric speaker). While some examples of sensory feedback parameters, sensory feedback parameter adjustment (e.g., by the system provider device and based on an amount to be debited), and customer device 600 components having adjustable sensory feedback parameters have been provided, those skilled in the art in possession of the present disclosure will recognize other sensory feedback parameters, methods of parameter adjustment, and/or other adjustable customer device 600 components, while remaining within the scope of the present disclosure.

Thus, following block 204, the system provider device has determined one or more sensory feedback parameters (e.g., amplitude, duration, period, and frequency) based on the amount specified to be debited from the customer payment account. As discussed below, having determined the sensory feedback parameters, the system provider device may thus provide haptic/tactile or audible feedback to the customer via the customer device, where such feedback includes a vibrational or audio profile, as described above, and which is based at least partly on the determined sensory feedback parameters.

The method 200 then proceeds to block 206 where the previously determined amount to be debited (block 202) is debited from the customer payment account. In various examples, the “customer payment account” described herein may include savings and/or checking accounts (and associated debit cards), lines of credit (and associated credit cards), and may further include a payment service provider account (e.g., a PayPal account), or other account, which is linked to one or more of such payment accounts. As discussed above, and in an embodiment of block 206, the payment service provider may use the payment service provider device 108 to transfer funds from the customer payment account of the customer to the merchant account of the merchant to provide payment from the customer to the merchant for goods provided and/or services rendered in the previously determined specified amount. Thus, following block 206, the system provider device has debited the determined amount from the customer payment account, and the system provider device may subsequently provide haptic/tactile or audible feedback (via the customer device) which is directly related to the amount debited from the customer payment account. However, other embodiments in which the haptic/tactile and/or audible feedback is provided to the customer before the amount is debited from the customer payment account will fall within the scope of the present disclosure as well.

The method 200 then proceeds to block 208 where haptic/tactile and/or audible feedback is provided to a user of the customer device, where such feedback conveys information regarding an amount debited from the customer payment account (e.g., for a given purchase transaction). As described above, the haptic/tactile and/or audible feedback may be based at least partly on the determined sensory feedback parameter (block 204). Additionally, as discussed above, triggering of the haptic/tactile and/or audible feedback may occur upon debiting of the determined amount from the customer payment account (block 206). Thus, in some cases, if an error in the amount debited is detected (e.g., by the user detecting unexpected haptic or audible feedback), then the customer may alert the merchant and/or the service provider, for example, to request a refund for any overcharged amounts, or to correct other transaction anomalies. Alternatively, in some embodiments, the haptic/tactile and/or audible feedback may be provided to the user of the customer device prior to the amount being debited, for example, in order to convey information regarding an amount that is about to be debited, and/or that has been authorized to be debited, from the customer payment account. Thus, in some embodiments, if an error in the amount about to be debited is detected (e.g., by the user detecting unexpected haptic or audible feedback), then the debit transaction may be cancelled prior to completion. Various examples of the haptic/tactile feedback 602 and/or the audible feedback 604 which may be provided have been discussed above with reference to FIGS. 6-8. For example, embodiments of block 208 may include vibration of the customer device via a component of the customer device 600 (e.g., vibrating motor, LRA, etc.) according to a vibrational profile determined at least partly by any of the plurality of sensory feedback parameters including amplitude, duration, period, frequency, and/or other parameters as known in the art. Similarly, some embodiments of block 208 may include an audio alert or other audible message output from speakers of the customer device (e.g., electrodynamic speaker, piezoelectric speaker) according to an audio profile determined at least partly by any of the plurality of sensory feedback parameters including amplitude, duration, period, frequency, and/or other parameters as known in the art. Thus, following block 208, the system provider device has provided haptic/tactile or audible feedback (via the customer device) directly related to the amount debited from the customer payment account, thereby allowing the customer to confirm the accuracy of any amounts debited, increasing the customer's trust and security.

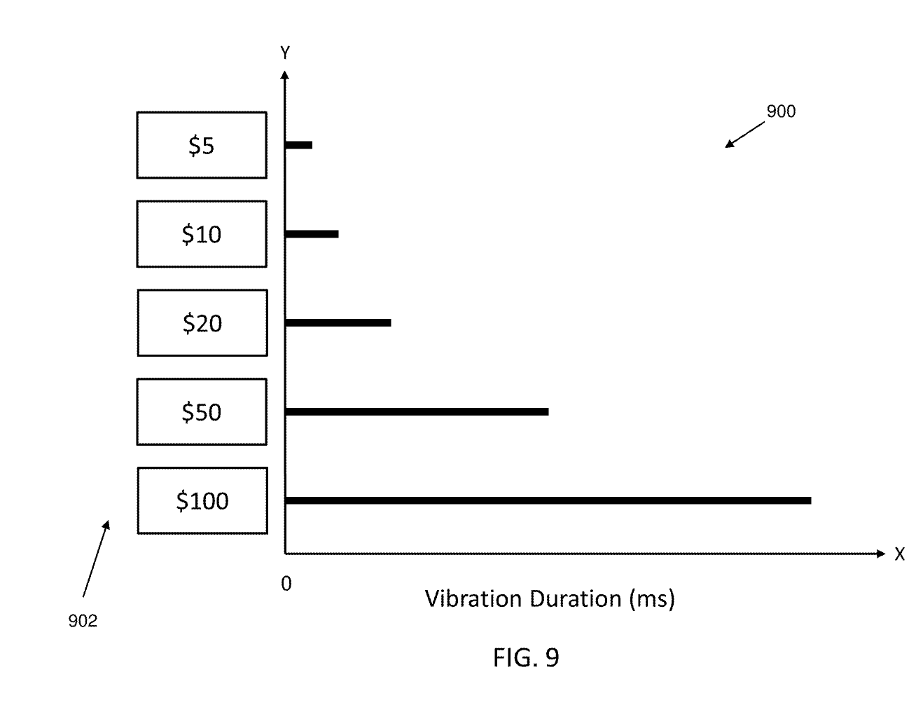

Referring to FIG. 9, illustrated therein is a bar graph 900 showing an example of adjusting a vibration duration based on the amount to be debited from the customer payment account. Specifically, FIG. 9 illustrates an example of linking/associating a specific banknote denomination to a specified vibration duration (e.g., specified by the service provider device). By way of example, a plurality of banknotes 902 of various denominations are shown along a Y-axis (including $5, $10, $20, $50, and $100), and a vibration duration along an X-axis. In various embodiments, the $5 banknote is linked to (associated with) a first vibration duration, the $10 banknote is linked to a second vibration duration, the $20 banknote is linked to a third vibration duration, the $50 banknote is linked to a fourth vibration duration, and the $100 banknote is linked to a fifth vibration duration. Illustratively, the first vibration duration is less than the second, third, fourth, and fifth vibration durations; the second vibration duration is greater than the first vibration duration, and less than the third, fourth, and fifth vibration durations; the third vibration duration is greater than the first and second vibration durations, and less than the fourth and fifth vibration durations; the fourth vibration duration is greater than the first, second, and third vibration durations, and less than the fifth vibration duration; and the fifth vibration duration is greater than the first, second, third, and fourth vibration durations. In some embodiments, the vibration durations (e.g., from first to fifth) may increase, for example according to a linear or logarithmic scale, and in direct relation to the banknote denomination. As merely one example, the $5 banknote may correspond to a 250 millisecond vibration duration, the $10 banknote may correspond to a 500 millisecond vibration duration, the $20 banknote may correspond to a 1 second vibration duration, the $50 banknote may correspond to a 2.5 second vibration duration, and the $100 banknote may correspond to a 5 second vibration duration.

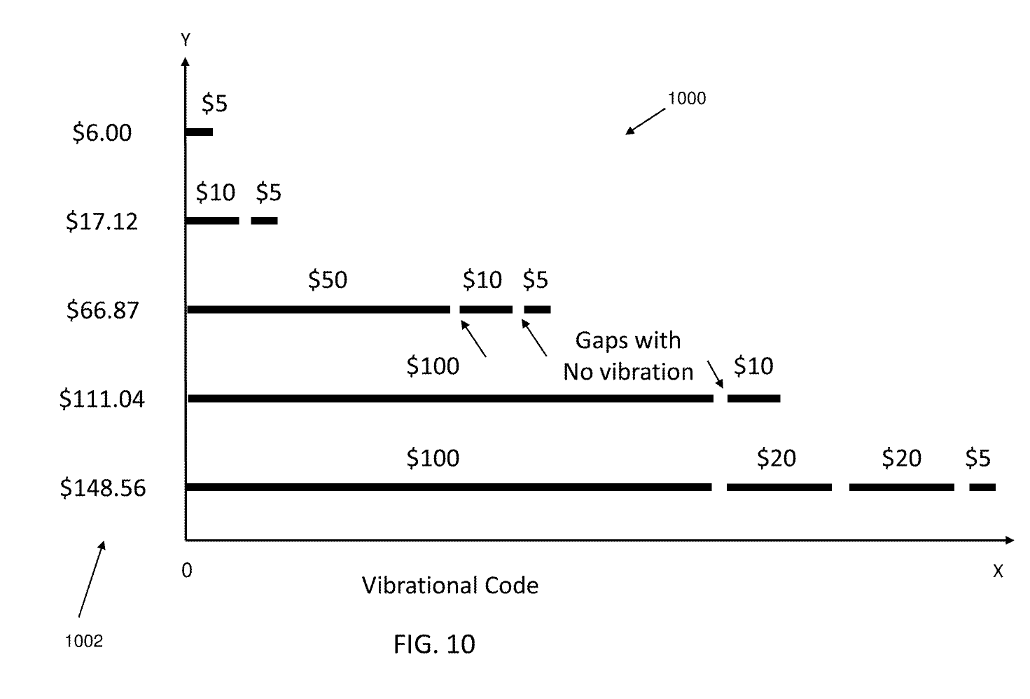

With reference to FIG. 10, illustrated therein is a bar graph 1000 showing an example of using the vibration duration-banknote denomination linkages (e.g., of FIG. 9) to represent various exemplary amounts which may be debited from the customer payment account. Specifically, FIG. 10 illustrates rounding amounts (e.g., charged by a merchant), for example down to the nearest value which may be represented by the denominations having a linked vibration duration. This may be done for the purpose of simply and effectively conveying, to a user of the customer device, an amount that closely approximates an actual value which has been debited (or which has been authorized to be debited) from a customer payment account. By way of illustration, a plurality of debit amounts 1002 are shown along a Y-axis (including $6, $17.12, $66.87, $111.04, and $148.56), and a vibrational code along an X-axis. As used herein, the “vibrational code” may be used to describe a series of vibrations, which may be of varying duration (e.g., such as described above with reference to FIG. 9), and which may have gaps of time (e.g., where there is no vibration) in between successive vibrations of the series of vibrations. As described herein, such a vibrational code may be used to convey the information to a user of the customer device regarding the approximate value of the amount that has been debited (or has been authorized to be debited) from the customer payment account. By way of illustration, the vibrational code may have features similar to Morse code, thus in some cases the vibration code may be referred to as a “Morse code of money”. Additionally, while described as a vibrational code, it will be understood that some embodiments may include an audio code, for example, having a sequence of successive audio alerts, tones, chimes, etc. separated by gaps of time where there is no audio output from the customer device. Thus, such an audio code may be similarly used to convey the information to a user of the customer device regarding the approximate value of the amount that has been debited (or has been authorized to be debited) from the customer payment account.

Continuing with the example of FIG. 10, and in some embodiments, the $6 debit amount may be rounded to $5, so that the vibrational code used to represent the $6 debit amount may include the vibration duration corresponding to the $5 banknote (as shown in FIG. 9). In some examples, the $17.12 debit amount may be rounded to $15, so that the vibrational code used to represent the $17.12 debit amount may include the vibration duration corresponding to the $10 banknote and the $5 banknote, separated by a gap of time without vibration. In a similar manner, the $66.87 debit amount may be rounded to $65, so that the vibrational code used to represent the $66.87 debit amount may include the vibration duration corresponding to the $50 banknote, the $10 banknote, and the $5 banknote, separated by gaps of time without vibration. As another example, the $111.04 debit amount may be rounded to $110, so that the vibrational code used to represent the $111.04 debit amount may include the vibration duration corresponding to the $100 banknote and the $10 banknote, separated by a gap of time without vibration. Likewise, the $148.56 debit amount may be rounded to $145, so that the vibrational code used to represent the $148.56 debit amount may include the vibration duration corresponding to the $100 banknote, two vibrations having the vibration duration corresponding to the $20 banknote, and the vibration duration corresponding to the $5 banknote, separated by gaps of time without vibration.

While the examples of FIGS. 9 and 10 were directed to linking a specific banknote denomination to a specified vibration duration and rounding amounts down to the nearest value which may be represented by the denominations having a linked vibration duration, respectively, those skilled in the art in possession of the present disclosure will recognize other linkages that may be made (e.g. using other sensory feedback parameters) and/or different methods of rounding or not rounding, while remaining within the scope of the present disclosure. For example, in various embodiments, different banknotes may be instead linked to a vibration amplitude, period, frequency, and/or to the duration, amplitude, period, or frequency of an audio alert/audible message output from the customer device. Additionally, in some embodiments, the amounts (e.g., charged by a merchant), may instead by rounded up to the nearest value which may be represented by the denominations having a linked vibration duration. Those of skill in the art will recognize the examples provided are merely for illustration and are not meant to be limiting in any way, beyond the claims that follow below.

Moreover, various additional examples may be implemented in accordance with the methods described herein, while remaining within the scope of the present disclosure. For example, in some embodiments, vibration of the customer device and/or audio alerts/audible messages output from the customer device may be triggered as a result of a push notification. As used herein, a “push notification” may be used to describe a server push notification, which may include conveying information to the customer device (e.g., from the service provider device) without a specific request from the customer device. In some cases, such a push notification may be triggered by a system provider application and/or a payment service provider application (e.g., a payment application provided by PayPal, Inc. of San Jose, Calif.). For instance, as one example, consider a first user having a first customer device including an instance of a PayPal payment application installed on the first customer device, and a second user having a second customer device including another instance of the PayPal payment application installed on the second customer device. In addition, consider that a customer payment account is associated with the PayPal payment application installed on each of the first and second customer devices. Thereafter, consider that the second user makes a purchase (e.g., conducted online or via a mobile payment system) using the second customer device, resulting in a debit from the customer payment account. As a result, the PayPal payment application installed on the first customer device may generate a push notification on the first customer device, thereby triggering vibration of the first customer device and/or audio alerts/audible messages output from the first customer device, as described above. While an example of generating a push notification to trigger haptic/tactile feedback and/or audio alerts/messages has been provided, those skilled in the art in possession of the present disclosure will recognize other methods of generating push notifications, while remaining within the scope of the present disclosure.

As another example, in some embodiments, embodiments of the present disclosure may be used to inform the user of the customer device regarding a remaining balance of funds in the customer payment account. For instance, in some embodiments, the remaining balance of the customer payment account may be provided to the user (by way of vibration of the first customer device and/or audio alerts/audible messages output from the first customer device) in response to a user query via the customer device. In other examples, a vibration and/or audio alert/message that represents the remaining balance may be concatenated with the vibration and/or audio alert/message that represents an amount that has been debited from the user payment account for a given transaction. Thus, some notifications to a user of the customer device may include two-part notifications, the first part including an amount debited, and a second part including a remaining balance of the customer payment account. In some embodiments, such two-part notifications may include a extended gap of time (e.g., around 10 seconds without vibrations or audio alerts/messages) between the first and seconds parts of the two-part notification. While some examples of notifying a user of the customer device of a remaining balance of the customer payment account have been provided, those skilled in the art in possession of the present disclosure will recognize other methods of conveying the remaining balance of the customer payment account, while remaining within the scope of the present disclosure.

In still other examples, embodiments of the present disclosure may be used to set limits on an amount that may be debited from the customer payment account. For example, in contrast to embodiments that provide haptic/tactile and/or audible feedback to convey information regarding an amount debited (as an output from the customer device), some embodiments may provide such feedback in response to a user setting a limit (as an input to the customer device) on an amount that may be debited from the customer payment account. By way of example, consider that a user of the customer device enters a coffee shop to make a purchase which the customer expects to be less than $10. In some embodiments, the user may set the $10 limit prior to making the purchase, for example, using any of a plurality of inputs of the customer device. For instance, the user may hold down a volume rocker button (e.g., while within the PayPal payment application) for an amount of time corresponding to the $10 limit that the user wants to set. To assist the user, the customer device may provide real-time feedback (e.g., vibration and/or audio alert/message) while the user is holding down the volume rocker, so that the user can readily detect the limit that has been set. While an example of using haptic/tactile feedback and/or audio alerts/messages as an input (e.g., to set a limit on an amount that may be debited from the customer payment account) has been provided, those skilled in the art in possession of the present disclosure will recognize other methods of using haptic/tactile feedback and/or audio alerts/messages as inputs, while remaining within the scope of the present disclosure.

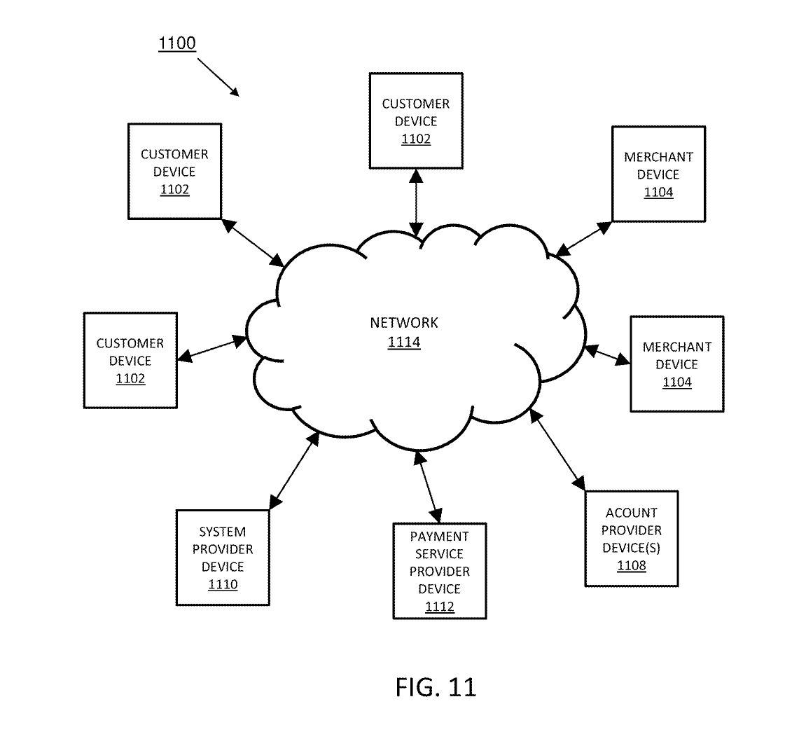

Thus, systems and methods have been described that provide for conveying information to a user of a customer device regarding an amount that was debited (or has been authorized to be debited) from a customer payment account, whereby such information is conveyed by way of haptic/tactile feedback (e.g., vibration of the customer device) and/or audio alerts/audible messages. In various examples, and in accordance with the various embodiments described herein, the system provider device may receive a request to debit a specified amount from the customer payment account (e.g., responsive to a purchase conducted online and/or via a mobile payment system), the system provider device may thereby determine one or more sensory feedback parameters based on the specified amount, and thereafter provide haptic/tactile feedback or audible feedback (via the customer device) directly related to the amount debited (or authorized to be debited) from the customer payment account, thereby allowing the customer to confirm the accuracy of any such amounts. Thus, the embodiments described herein provide customers with a reliable and transparent way to physicalize purchase transactions conducted online and/or via a mobile payment system, thereby increasing the trust, security, and accessibility of using electronic currency. It is additionally noted that the embodiments described herein describe technological solutions to problems associated with the handling of currency or other monetary instruments (e.g., with respect to e-commerce, electronic currency, and digital wallets) that did not exist prior to the advent of computer networks and the Internet. Various examples of technological devices and systems that may be used to implement embodiments of the present disclosure are discussed in more detail below with reference to FIGS. 11-14.

Referring first to FIG. 11, an embodiment of a network-based system 1100 for implementing one or more processes described herein is illustrated. As shown, the network-based system 1100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 11 may be deployed in other ways and that the operations performed and/or the services provided by such servers may be combined or separated for a given implementation and may be performed by a greater number or fewer number of servers. One or more servers may be operated and/or maintained by the same or different entities.

The embodiment of the networked system 1100 illustrated in FIG. 11 includes a plurality of customer devices 1102, a plurality of merchant devices 1104, a payment service provider device 1112, account provider device(s) 1108, and/or a system provider device 1110 in communication over one or more networks 1114. The customer devices 1102 may be the customer devices discussed above and may be operated by the customers discussed above. The merchant devices 1104 may be the merchant devices discussed above and may be operated by the merchants discussed above. The payment service provider device 1112 may be the payment service provider devices discussed above and may be operated by a payment service provider such as, for example, PayPal Inc. of San Jose, Calif. The system provider devices 1110 may be the system provider devices discussed above and may be operated by the system providers discussed above. The account provider devices 1108 may be operated by credit card account providers, bank account providers, savings account providers, and a variety of other account providers known in the art.

The customer devices 1102, merchant devices 1104, payment service provider device 1112, account provider devices 1108, and/or system provider device 1110 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 1100, and/or accessible over the network 1114.

The network 1114 may be implemented as a single network or a combination of multiple networks. For example, in various embodiments, the network 1114 may include the Internet and/or one or more intranets, landline networks, wireless networks, and/or other appropriate types of networks.

The customer devices 1102 may be implemented using any appropriate combination of hardware and/or software configured for wired and/or wireless communication over network 1114. For example, in one embodiment, the customer devices 1102 may be implemented as a personal computer of a user in communication with the Internet. In other embodiments, the customer devices 1102 may be a smart phone, wearable computing device, laptop computer, and/or other types of computing devices.

The customer devices 1102 may include one or more browser applications which may be used, for example, to provide a convenient interface to permit the customer to browse information available over the network 1114. For example, in one embodiment, the browser application may be implemented as a web browser configured to view information available over the Internet.

The customer devices 1102 may also include one or more toolbar applications which may be used, for example, to provide user-side processing for performing desired tasks in response to operations selected by the customer. In one embodiment, the toolbar application may display a user interface in connection with the browser application.

The customer devices 1102 may further include other applications as may be desired in particular embodiments to provide desired features to the customer devices 1102. In particular, the other applications may include a payment application for payments assisted by a payment service provider through the payment service provider device 1112. The other applications may also include security applications for implementing user-side security features, programmatic user applications for interfacing with appropriate application programming interfaces (APIs) over the network 1114, or other types of applications. Email and/or text applications may also be included, which allow customer payer to send and receive emails and/or text messages through the network 1114. The customer devices 1102 includes one or more user and/or device identifiers which may be implemented, for example, as operating system registry entries, cookies associated with the browser application, identifiers associated with hardware of the customer devices 1102, or other appropriate identifiers, such as a phone number. In one embodiment, the user identifier may be used by the payment service provider device 1112 and/or account provider device 1108 to associate the user with a particular account as further described herein.

The merchant devices 1104 may be maintained, for example, by a conventional or on-line merchant, conventional or digital goods seller, individual seller, and/or application developer offering various products and/or services in exchange for payment to be received conventionally or over the network 1114. In this regard, the merchant device 1104 may include a database identifying available products and/or services (e.g., collectively referred to as items) which may be made available for viewing and purchase by the customer.

The merchant devices 1104 also include a checkout application which may be configured to facilitate the purchase by the payer of items. The checkout application may be configured to accept payment information from the user through the customer devices 1102, the account provider through the account provider device 1108, and/or from the payment service provider through the payment service provider device 1112 over the network 1114.

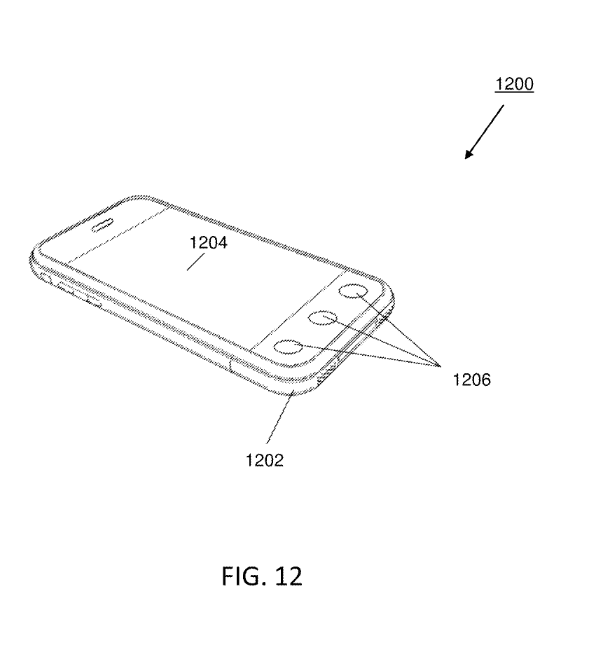

Referring now to FIG. 12, an embodiment of a customer device 1200 is illustrated. The customer device 1200 may be the customer device 300, 500, or 600 discussed above. The customer device 1200 includes a chassis 1202 having a display 1204 and an input device including the display 1204 and a plurality of input buttons 1206. One of skill in the art will recognize that the customer device 1200 is a portable or mobile phone including a touch screen input device and a plurality of input buttons that allow the functionality discussed above with reference to the methods above. However, a variety of other portable/mobile customer devices and/or desktop customer devices may be used in the methods discussed above without departing from the scope of the present disclosure.

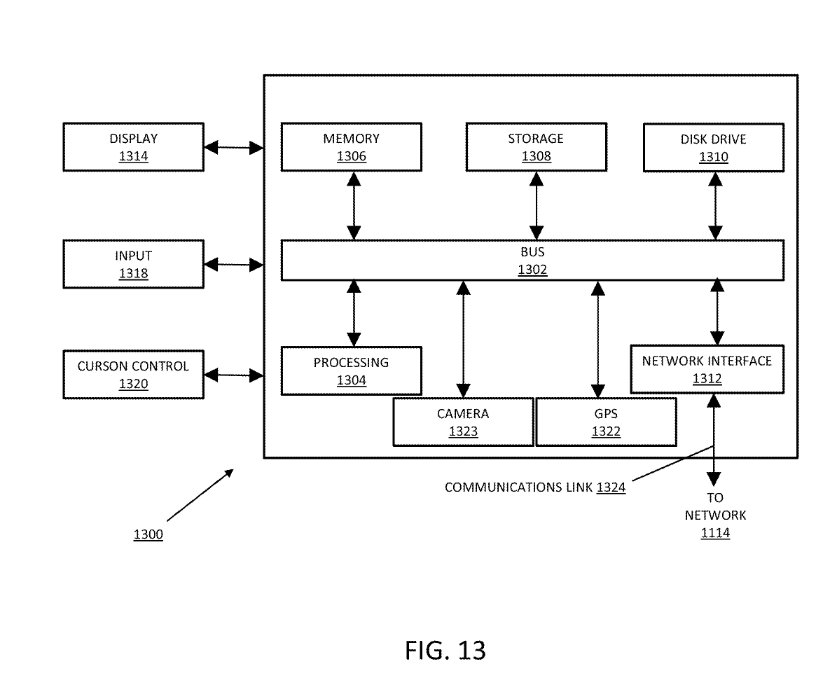

Referring now to FIG. 13, an embodiment of a computer system 1300 suitable for implementing, for example, the customer device 300, 500, or 600, the merchant device 1104, the payment service provider device 1112, the account provider device(s) 1108, and/or the system provider devices 108 or 1110, is illustrated. It should be appreciated that other devices utilized by customers, merchants, beacon devices, merchant beacon communication devices, payment service providers, account provider device(s), and/or system providers in the system discussed above may be implemented as the computer system 1300 in a manner as follows.

In accordance with various embodiments of the present disclosure, computer system 1300, such as a computer and/or a network server, includes a bus 1302 or other communication mechanism for communicating information, which interconnects subsystems and components, such as a processing component 1304 (e.g., processor, micro-controller, digital signal processor (DSP), etc.), a system memory component 1306 (e.g., RAM), a static storage component 1308 (e.g., ROM), a disk drive component 1310 (e.g., magnetic or optical), a network interface component 1312 (e.g., modem or Ethernet card), a display component 1314 (e.g., CRT or LCD), an input component 1318 (e.g., keyboard, keypad, or virtual keyboard), a cursor control component 1320 (e.g., mouse, pointer, or trackball), a location determination component 1322 (e.g., a Global Positioning System (GPS) device as illustrated, a cell tower triangulation device, and/or a variety of other location determination devices known in the art), and/or a camera component 1323. In one implementation, the disk drive component 1310 may comprise a database having one or more disk drive components.

In accordance with embodiments of the present disclosure, the computer system 1300 performs specific operations by the processor 1304 executing one or more sequences of instructions contained in the memory component 1306, such as described herein with respect to the customer devices 300, 500, or 600, the merchant device 1104, the payment service provider device 1112, the account provider device(s) 1108, and/or the system provider devices 402 or 1110. Such instructions may be read into the system memory component 1306 from another computer readable medium, such as the static storage component 1308 or the disk drive component 1310. In other embodiments, hard-wired circuitry may be used in place of or in combination with software instructions to implement the present disclosure.

Logic may be encoded in a computer readable medium, which may refer to any medium that participates in providing instructions to the processor 1304 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 1310, volatile media includes dynamic memory, such as the system memory component 1306, and transmission media includes coaxial cables, copper wire, and fiber optics, including wires that comprise the bus 1302. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the present disclosure, execution of instruction sequences to practice the present disclosure may be performed by the computer system 1300. In various other embodiments of the present disclosure, a plurality of the computer systems 1300 coupled by a communication link 1324 to the network 1114 (e.g., such as a LAN, WLAN, PTSN, and/or various other wired or wireless networks, including telecommunications, mobile, and cellular phone networks) may perform instruction sequences to practice the present disclosure in coordination with one another.

The computer system 1300 may transmit and receive messages, data, information and instructions, including one or more programs (i.e., application code) through the communication link 1324 and the network interface component 1312. The network interface component 1312 may include an antenna, either separate or integrated, to enable transmission and reception via the communication link 1324. Received program code may be executed by processor 1304 as received and/or stored in disk drive component 1310 or some other non-volatile storage component for execution.

Referring now to FIG. 14, an embodiment of a system provider device 1400 is illustrated. In an embodiment, the device 1400 may be the system provider devices discussed above. The device 1400 includes a communication engine 1402 that is coupled to the network 1114 and to sensory feedback engine 1404 that is coupled to a customer information database 1406 and a sensory feedback parameter database 1408. The communication engine 1402 may be software or instructions stored on a computer-readable medium that allows the device 1400 to send and receive information over the network 1114. The sensory feedback engine 1404 may be software or instructions stored on a computer-readable medium that, when executed by a processor, is configured receive a request to debit a first amount from a customer payment account, determine at least one sensory feedback parameter based on the first amount, debit the first amount from the customer payment account (e.g., to pay a merchant), and provide haptic/tactile feedback and/or audio alerts/audible messages by way of the customer device based at least partly on the determined at least one sensory feedback parameter, as well as provide any of the other functionality that is discussed above. While the databases 1406 and 1408 have been illustrated as located in the device 1400, one of skill in the art will recognize that they may be connected to the sensory feedback engine 1404 through the network 1114 without departing from the scope of the present disclosure.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on merchants and customers; however, a customer or consumer can pay, or otherwise interact with any type of recipient, including charities and individuals. The payment does not have to involve a purchase, but may be a loan, a charitable contribution, a gift, etc. Thus, merchant as used herein can also include charities, individuals, and any other entity or person receiving a payment from a customer. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A sensory feedback payment system, comprising:
a non-transitory memory storing sensory feedback parameter information; and
one or more hardware processors coupled to the non-transitory memory and configured to read instructions from the non-transitory memory to cause the system to perform operations comprising:
receiving a request to debit an amount from a customer payment account;
determining at least one sensory feedback parameter based on the amount;
debiting the amount from the customer payment account; and
responsive to debiting the amount, sending an instruction to provide sensory feedback to a user through a customer device, wherein the sensory feedback is at least partly determined by the at least one sensory feedback parameter.

2. The system of claim 1, wherein the sensory feedback includes at least one of vibrational feedback and audio feedback.

3. The system of claim 1, wherein the customer payment account includes one of a savings account, a checking account, a credit account, and a payment service provider account.

4. The system of claim 1, wherein the receiving the request to debit the first amount from the customer payment account is triggered by a near field communication (NFC) transaction.

5. The system of claim 1, wherein the at least one sensory feedback parameter includes one of an amplitude, a duration, a period, and frequency.

6. The system of claim 1, wherein the at least one sensory feedback parameter defines at least one of a vibrational profile and an audio profile.

7. The system of claim 1, wherein the at least one sensory feedback parameter is used to adjust at least one of a vibration intensity, a vibration duration, a vibration frequency, an audio alert intensity, an audio alert duration, and an audio alert frequency.

8. The system of claim 1, wherein the sensory feedback conveys information regarding a remaining balance of funds in the customer payment account.

9. The system of claim 1, wherein the one or more hardware processors are further configured to read instructions from the at least one non-transitory memory to cause the system to perform operations comprising:
linking a first banknote denomination to a first value of the at least one sensory feedback parameter and a second banknote denomination to a second value of the at least one sensory feedback parameter; and
generating at least one of a vibrational code and an audio code that conveys an approximate value of the amount to the user.

10. The system of claim 1, wherein the one or more hardware processors are further configured to read instructions from the at least one non-transitory memory to cause the system to perform operations comprising:
debiting the amount from the customer payment account based on a purchase transaction by another user;
in response to the purchase transaction by the another user, sending a push notification to the customer device that is configure to cause the customer device to provide the sensory feedback to the user.

11. The system of claim 1, wherein the one or more hardware processors are further operable to read instructions from the at least one non-transitory memory to perform the steps of:
prior to receiving the request to debit the amount, receiving an input from the customer device that sets a debit amount limit;
determining the least one sensory feedback parameter based on the debit limit amount; and
responsive to receiving the input that sets debit limit amount, sending the instruction to provide the sensory feedback to the user through the customer device.

12. A method for providing sensory feedback to a customer in response to a payment transaction, comprising:
receiving, by a system provider device through a network, a request to debit an amount from a customer payment account;
determining, by the system provider device, at least one sensory feedback parameter based on the amount;
debiting, by the system provider device, the amount from the customer payment account; and
responsive to debiting the amount, sending, by the system provider device, an instruction to provide sensory feedback to a user through a customer device, wherein the sensory feedback is at least partly determined by the at least one sensory feedback parameter.

13. The method of claim 12, wherein the sensory feedback includes at least one of vibrational feedback and audio feedback.

14. The method of claim 12, wherein the at least one sensory feedback parameter includes one of an amplitude, a duration, a period, and frequency.

15. The method of claim 12, wherein the at least one sensory feedback parameter is used to adjust at least one of a vibration intensity, a vibration duration, a vibration frequency, an audio alert intensity, an audio alert duration, and an audio alert frequency.

16. The method of claim 12, further comprising:
linking, by the system provider device, a first banknote denomination to a first value of the at least one sensory feedback parameter and a second banknote denomination to a second value of the at least one sensory feedback parameter; and
generating, by the system provider device, at least one of a vibrational code and an audio code that conveys an approximate value of the amount to the user.

17. A non-transitory machine-readable medium having stored thereon machine-readable instructions executable to cause a machine to perform operations comprising:
receiving a request to debit an amount from a customer payment account;
determining at least one sensory feedback parameter based on the amount;
debiting the amount from the customer payment account; and
responsive to debiting the amount, sending an instruction to provide sensory feedback to a user through a customer device, wherein the sensory feedback is at least partly determined by the at least one sensory feedback parameter.

18. The non-transitory machine-readable medium of claim 17, wherein the sensory feedback includes at least one of vibrational feedback and audio feedback.

19. The non-transitory machine-readable medium of claim 17, wherein the at least one sensory feedback parameter is used to adjust at least one of a vibration intensity, a vibration duration, a vibration frequency, an audio alert intensity, an audio alert duration, and an audio alert frequency.

20. The non-transitory machine-readable medium of claim 17, wherein the method further comprises:
linking, by the system provider device, a first banknote denomination to a first value of the at least one sensory feedback parameter and a second banknote denomination to a second value of the at least one sensory feedback parameter; and
generating, by the system provider device, at least one of a vibrational code and an audio code that conveys an approximate value of the amount to the user.
